(19) United States
(12) Patent Application Publication
(10) Pub. No.: US 2022/0137609 A1
(43) Pub. Date: May 5, 2022

(54) PRODUCTION INFORMATION MANAGEMENT SYSTEM AND PRODUCTION INFORMATION MANAGEMENT METHOD

(71) Applicant: HITACHI, LTD., Tokyo (JP)

(72) Inventors: Daisuke TSUTSUMI, Tokyo (JP); Shota UMEDA, Tokyo (JP); Keita NOGI, Tokyo (JP)

(21) Appl. No.: 17/504,557

(22) Filed: Oct. 19, 2021

(30) Foreign Application Priority Data
Nov. 2, 2020 (JP) 2020-183743

(51) Int. Cl. G05B 19/418

(52) U.S. Cl. CPC G05B 19/41885; G05B 19/4183; G05B 19/41875; G05B 19/4188

(57) ABSTRACT

A production information management system includes: a storage device that stores 4M (man, machine, material, and method) data information including time series data in which a state of each element of 4M per unit time is associated with acquisition accuracy of 4M data defined for each target and acquisition method of 4M, and analysis model information defining a criterion for determining a production loss from a combination of the 4M data information; a processor that analyzes the 4M data information by the analysis model information to estimate a production loss, and calculates estimation accuracy for the each production loss to generate production loss information; and a production loss display unit that displays the production loss information.

### CROSS-REFERENCE TO RELATED APPLICATION

The present application claims priority from Japanese application JP 2020-183743, filed on Nov. 2, 2020, the contents of which is hereby incorporated by reference into this application.

### BACKGROUND OF THE INVENTION

### 1. Field of the Invention

The present invention relates to a production information management system and a production information management method.

### 2. Description of the Related Art

JP Patent No. 6540481 describes “A management system for managing the quality of manufacturing facilities, the management system including: acquisition means for acquiring state information on a management object manufacturing facility; determination means for determining whether or not an event has occurred based on the acquired state information; display means for displaying indexes indicating possibilities of existence of factors that caused an event from four viewpoints of machine, man, material and method together with an image indicating a manufacturing line included in the manufacturing facilities schematically or realistically; and output means for outputting, when a particular event occurs, analysis results indicating the possibilities of having caused the occurring particular event regarding each of one or more factors belonging to each of the four viewpoints in response to a user's selection, wherein the display means can display, in a form of drill down or drill up, a first display screen that displays an operation state of one or a plurality of manufacturing lines; a second display screen that displays one or a plurality of processes included in a manufacturing line selected on the first display screen; and a third display screen that displays an operation state of a process selected on the second display screen, an operation state displayed on the third display screen includes one or a plurality of events occurred in a corresponding process, and the output means receives the user selection on the third display screen”.

### SUMMARY OF THE INVENTION

In the technique described in JP Patent No. 6540481 described above, an abnormal state is determined from information of machine among factors (4M data) belonging to the four viewpoints including machine, man, material, and method. Information of machine can be acquired with high accuracy, but the production loss caused by the factors other than machine cannot be estimated. For example, it is not possible to appropriately estimate the reason why the machine has stopped.

An object of the present invention is to indicate production loss information in consideration of acquisition accuracy and estimation accuracy of site data (4M data).

The present application includes a plurality of means for solving at least some of the above problems, but examples thereof are as follows.

One aspect of the present invention is a production information management system including: a storage device that stores 4M (man, machine, material, and method) data information including time series data in which a state of each element of 4M per unit time is associated with acquisition accuracy of 4M data defined for each target and acquisition method of 4M, and analysis model information defining a criterion for determining a production loss from a combination of the 4M data information; a processor that analyzes the 4M data information by the analysis model information to estimate a production loss, and calculates estimation accuracy for the each production loss to generate production loss information; and a production loss display unit that displays the production loss information.

According to the present invention, it is possible to provide a technology for indicating production loss information in consideration of acquisition accuracy and estimation accuracy of site data.

Problems, configurations, and effects other than those described above will be made clear by the description of the following embodiments.

### BRIEF DESCRIPTION OF THE DRAWINGS

FIG. 1 is a diagram illustrating an example of a configuration of a production information management system;

FIG. 2 is a diagram illustrating an example of a data flow according to input and output;

FIG. 3 is a diagram illustrating an example of a utility form of the production information management system;

FIG. 4 is a diagram illustrating an example of a hardware configuration of the production information management system;

FIG. 5 is a table illustrating an example of a data structure of 4M data acquisition accuracy definition information;

FIG. 6 is a table illustrating an example of a data structure of 4M data;

FIG. 7 is a table illustrating an example of a data structure of a production loss analysis model by combination of 4M data;

FIG. 8 is a table illustrating an example of a data structure of production loss information;

FIG. 9 is a view illustrating an example of a loss estimation result display screen;

FIG. 10 is a view illustrating an example of a rank display screen of a production loss calculation result in a predetermined period;

FIG. 11 is a table illustrating an example of a data structure of improvement countermeasure definition information;

FIG. 12 is a view illustrating an example of an improvement countermeasure display screen that displays improvement countermeasures in real time;

FIG. 13 is a view illustrating an example of a flowchart of improvement countermeasure specification processing;

FIG. 14 is a view illustrating an example of a flowchart of production loss estimation accuracy calculation processing;

FIG. 15 is a view illustrating an example of a data flow according to input and output of a second embodiment;

FIG. 16 is a table illustrating an example of a data structure of production loss occurrence frequency information;

FIG. 17 is a table illustrating an example of a data structure of erroneous estimation influence degree information;

FIG. 18 is a table illustrating an example of a data structure of 4M data acquisition configuration plan information;

FIG. 19 is a view illustrating an example of a flowchart of 4M data acquisition configuration plan calculation processing; and

FIG. 20 is a view illustrating an example of a 4M data acquisition configuration plan display screen.

### DESCRIPTION OF THE PREFERRED EMBODIMENTS

In the following embodiments, where necessary for the sake of convenience, the descriptions will be given separately regarding a plurality of sections or embodiments, but unless otherwise specified, they are not unrelated to one another, and one is in a relationship such as a modification, a detail, or supplementary explanation of some or all of the others.

In the following embodiments, where the number of elements or the like (including the numbers of items, numerical values, quantities, and ranges) are mentioned, the number of elements or the like is not limited to the specific number and may be equal to or greater than or equal to or less than the specific number, unless otherwise specified or except a case of being clearly limited in principle to the specific number.

In the following embodiments, it is needless to say that the components (including element steps) are not necessarily essential, unless otherwise specified or except a case of being considered to be clearly essential in principle.

Similarly, in the following embodiments, where the shape, positional relationship, and the like of the components and the like are mentioned, the components and the like include those substantially approximate or similar to the shape and the like, unless otherwise specified or except a case of being clearly considered otherwise in principle. The same is true for the above numerical values and ranges.

In all the drawings for explaining the embodiments, the same parts are given the same reference numerals in principle, and the repetition of the explanation will be omitted. However, even the same member may be given another reference sign or name in a case where it is highly likely to cause confusion if the same name is shared with a member before being changed due to environmental change or the like. Each embodiment of the present invention will be described below with reference to the drawings.

One of the purposes of manufacturing management is to improve productivity. One method for improving productivity is to reduce production loss. Here, the “production loss” is a generic term for various factors that inhibit maximization of output by the production system in the production activity. In the present invention, production loss is a concept commonly recognized in general activities such as total productive maintenance (TPM), and a specific example includes a factor of downtime of the production activity.

In the following embodiments, the field data is indicated as 4M data: man, machine, material, and method, but the present invention is not limited thereto. For example, the field data may be 5M data (4M data+Measure) or 5M+E data (5M data+Environment).

It is said that if all the site data can be acquired with error-free accuracy, more detailed production loss can be estimated by combining site data other than machine. However, in reality, errors are mixed in the site data, and hence if the number of targets of the site data is unnecessarily increased, data that cannot be acquired with high accuracy will also be mixed. Therefore, the possibility of erroneously estimating the production loss by combination of the site data increases.

If the estimation of the production loss is erroneous, countermeasures based on the estimation will also be erroneous, and thus productivity will not be improved. The estimation accuracy of the production loss decreases by multiplication of the acquisition accuracy of the site data to be combined. It is required to appropriately present the priority order of the countermeasure plans in consideration of the estimation accuracy of the production loss.

In the following description, the “input/output unit”, the “display unit”, and the “interface device” may be one or more interface devices. The one or more interface devices may be at least one of the following.
One or more input/output (I/O) interface devices. An input/output (I/O) interface device is an interface device for at least one of the I/O device and a remote display computer. The I/O interface device for the display computer may be a communication interface device. The at least one I/O device may be any of a user interface device, e.g., an input device such as a keyboard and a pointing device, and an output device such as a display device.
One or more communication interface devices. The one or more communication interface devices may be one or more communication interface devices of the same type (e.g., one or more network interface cards (NIC)) or two or more communication interface devices of different types (e.g., an NIC and a host bus adapter (HBA)).

In the following description, the “memory” is one or more memory devices that are examples of one or more storage devices, and may typically be a main storage device. The at least one memory device in the memory may be a volatile memory device or a nonvolatile memory device.

In the following description, the “persistent storage device” may be one or more persistent storage devices that are examples of one or more storage devices. The persistent storage device may typically be a nonvolatile storage device (e.g., an auxiliary storage device), and specifically may be, for example, a hard disk drive (HDD), a solid state drive (SSD), a non-volatile memory express (NVME) drive, or a storage class memory (SCM).

In the following description, the “storage unit” or the “storage device” may be a memory or both of a memory and a persistent storage device.

In the following description, the “processing unit” or the “processor” may be one or more processor devices. The at least one processor device may typically be a microprocessor device such as a central processing unit (CPU), but may also be another type of processor device such as a graphics processing unit (GPU). The at least one processor device may be single-core or multi-core. The at least one processor device may be a processor core. The at least one processor device may be a processor device in a broad sense such as a circuit (e.g., a field-programmable gate array (FPGA), a complex programmable logic device (CPLD), or an application specific integrated circuit (ASIC)) that is an aggregate of gate arrays in a hardware description language for performing a part or the entirety of processing.

In the following description, a function will sometimes be described with an expression “yyy unit”, but the function may be implemented by executing one or more computer programs by a processor, may be implemented by one or more hardware circuits (e.g., FPGA or ASIC), or may be implemented by a combination thereof. In a case where the function is implemented by the processor executing a program, determined processing is performed using the storage device and/or the interface device or the like as appropriate, and thus, the function may be at least a part of the processor. The processing described with the function as a subject may be processing performed by a processor or a device including the processor. The program may be installed from a program source. The program source may be, for example, a program distribution computer or a computer-readable recording medium (e.g., a non-transitory recording medium). The description of each function is an example, and a plurality of functions may be put together into one function or one function may be divided into a plurality of functions.

In the following description, there is a case where processing is described with “program” or “processing unit” as a subject, but the processing described with the program as a subject may be processing performed by a processor or a device including the processor. Two or more programs may be implemented as one program, or one program may be implemented as two or more programs.

In the following description, information from which an output is obtained with respect to an input may be described with an expression such as “xxx table”, but the information may be a table having any structure, or may be a learning model represented by a neural network, a genetic algorithm, or a random forest that generates an output with respect to an input. Therefore, “xxx table” can be referred to as “xxx information”. In the following description, the configuration of each table is an example, and one table may be divided into two or more tables, or the entirety or a part of two or more tables may be one table.

In the following description, the “production information management system” may be a system including one or more physical computers, or may be a system (e.g., a cloud computing system) implemented on a physical calculation resource group (e.g., a cloud infrastructure). That the production information management system “displays” display information may mean that the display information is displayed on a display device of a computer, or may mean that the computer transmits the display information to the display computer (in the latter case, the display information is displayed by the display computer).

### First Embodiment

In the present embodiment, an example will be described in which loss estimation accuracy is calculated based on site data (in the present embodiment, 4M data) acquisition accuracy, and priority order of countermeasures for improving productivity is presented based on a calculation result.

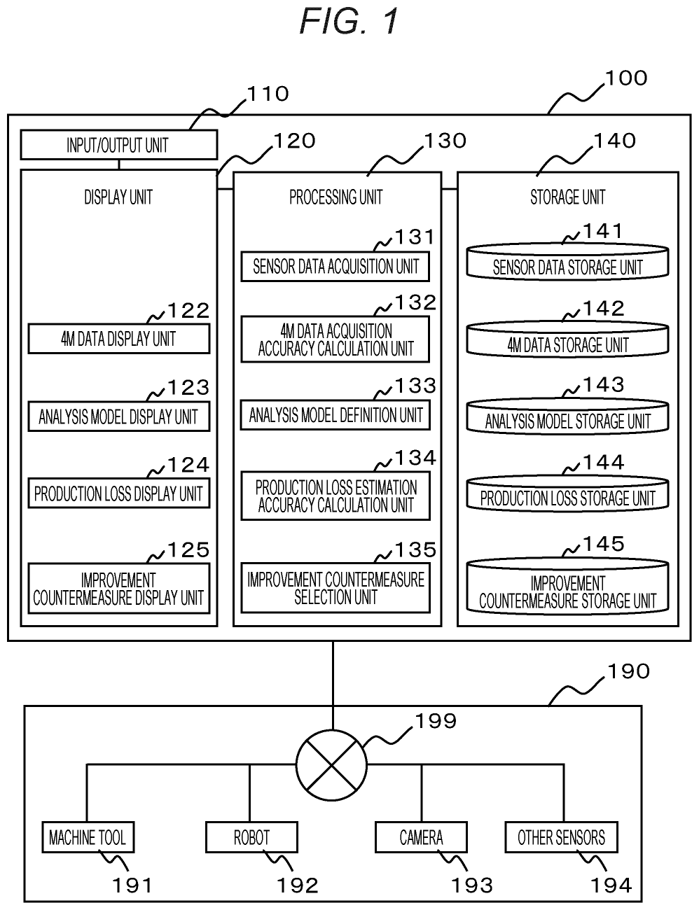

FIG. 1 is a diagram illustrating an example of the configuration of a production information management system. A production information management system 100 includes an input/output unit 110, a display unit 120, a processing unit 130, and a storage unit 140. The display unit 120 includes a 4M data display unit 122, an analysis model display unit 123, a production loss display unit 124, and an improvement countermeasure display unit 125. The processing unit 130 includes a sensor data acquisition unit 131, a 4M data acquisition accuracy calculation unit 132, an analysis model definition unit 133, a production loss estimation accuracy calculation unit 134, and an improvement countermeasure selection unit 135. The storage unit 140 includes a sensor data storage unit 141, a 4M data storage unit 142, an analysis model storage unit 143, a production loss storage unit 144, and an improvement countermeasure storage unit 145.

The production information management system 100 is connected to a manufacturing site 190 via a communication network (e.g., a local area network (LAN), a wide area network (WAN), or the Internet) 199. Additionally, the communication network 199 may be, for example, any of a virtual private network (VPN), a communication network partially or entirely using a general public line such as the Internet, a mobile phone communication network, and the like, or a network in which these are combined. The communication network 199 may be a wireless communication network such as Wi-Fi (registered trademark) or 5th generation (5G).

At the manufacturing site 190 has a manufacturing system (e.g., a line manufacturing system, a job shop manufacturing system, or a cell manufacturing system). The manufacturing system is provided with, for example, one or a plurality of machine tools 191 and robots 192. The machine tool 191 and the robot 192 are examples of elements belonging to machine, and are manufacturing facilities, for example.

The manufacturing site 190 is provided with a material management device that manages elements (e.g., a workpiece) belonging to material, a method management device that manages elements (e.g., a tool) belonging to method, and a man management device that manages elements (e.g., a worker) belonging to man. In the present embodiment, in order to simplify the description, it is assumed that the element belonging to material is a workpiece, the element belonging to method is a tool, and the element belonging to man is a worker.

The manufacturing site 190 is installed with a plurality of cameras 193. Each camera 193 captures a video. Captured video data that expresses the captured video is transmitted to the production information management system 100. Not video data but only information such as the presence/absence state of the worker and the presence/absence state of the workpiece detected by video analysis may be transmitted to the production information management system 100.

The manufacturing site 190 is installed with a plurality of other sensors 194. The other sensors 194 include a device that acquires motion information of a worker who operates the machine tool, e.g., an acceleration sensor, a heart rate sensor, and a temperature sensor. The other sensors 194 record information such as time point of start of operation, operation state, non-operation state, and end of operation of the worker. Similarly to the camera 193, these sensors may transmit, to the production information management system 100, only sensor data or 4M state information obtained by sensing.

Data (e.g., data including a measurement time point and a measurement value) measured by a plurality of devices, cameras, and sensors installed at the manufacturing site 190 are sent from each of the plurality of devices to a sensor data storage unit 141 or a 4M data storage unit 142 through a gateway and stored.

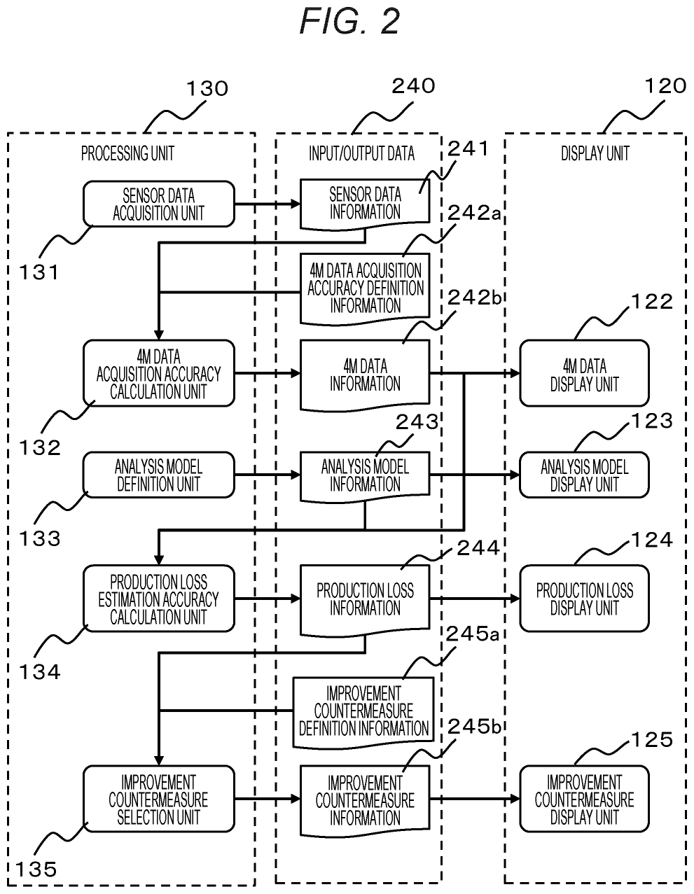

FIG. 2 is a diagram illustrating an example of the data flow according to input and output by the production information management system. Input/output data 240 presented at the center is information corresponding to the information stored in various databases of the storage unit 140 of FIG. 1. The processing unit 130 and the display unit 120 are common to FIGS. 1 and 2.

The sensor data acquisition unit 131 acquires data from a device, a sensor, or the like connected to the manufacturing site 190, and outputs sensor data information 241.

The 4M data acquisition accuracy calculation unit 132 uses the sensor data information 241 and 4M data acquisition accuracy definition information 242a as inputs, and outputs 4M data information 242b. The 4M data display unit 122 displays the 4M data information 242b. Specifically, the 4M data display unit 122 visualizes and displays a graph of the ratio of the 4M data acquisition accuracy per unit time.

The analysis model definition unit 133 generates analysis model information 243. Specifically, the analysis model definition unit 133 edits the determination criterion of the analysis model information, i.e., the determination flow and the association with the 4M data information for determination. The generation result, and the history before/after and middle of editing of the analysis model information are displayed by the analysis model display unit 123.

The production loss estimation accuracy calculation unit 134 uses the 4M data information 242b and the analysis model information 243 as inputs, and outputs production loss information 244. The production loss information is visualized and displayed by the production loss display unit 124 as a graph of the ratio of the production loss estimation accuracy per unit time.

The improvement countermeasure selection unit 135 uses the production loss information 244 and improvement countermeasure definition information 245a as inputs, and outputs improvement countermeasure information 245b. The improvement countermeasure display unit 125 displays the improvement countermeasure information 245b.

The data flow illustrated in FIG. 2 is an example, and may be different depending on a modification of the present embodiment.

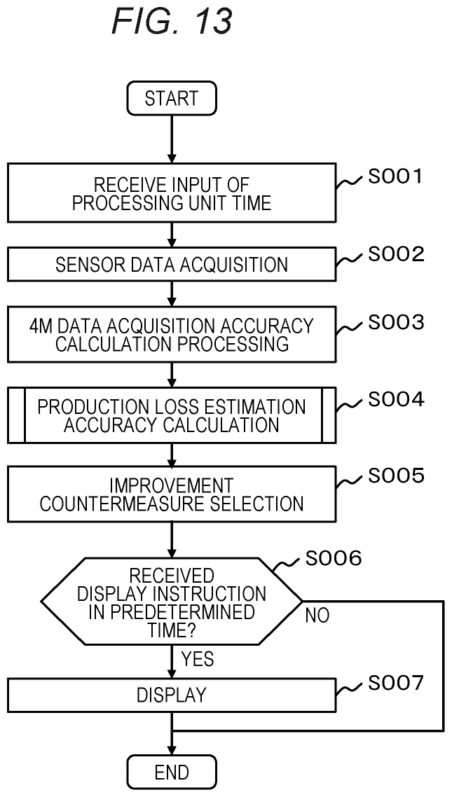

Details of the execution procedure of the production information management system 100 will be described later with reference to FIG. 13 using a flowchart and subsequent drawings.

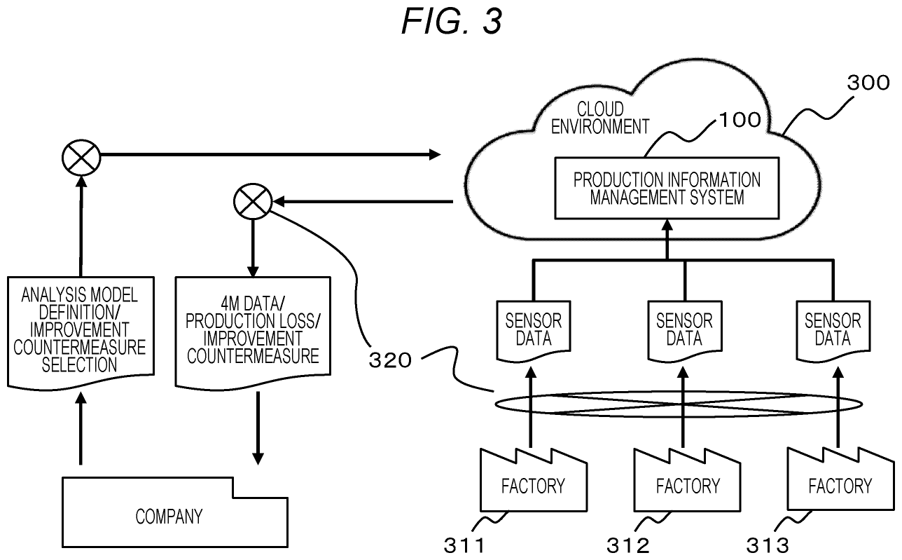

FIG. 3 is a diagram illustrating an example of the utility form of the production information management system. By accepting (receiving) input information related to production in all producible factories 311, 312, and 313 via a network 320 such as the Internet, and outputting (transmitting) improvement countermeasure information suitable for each production line included in all the factories 311, 312, and 313 via the network 320, the production information management system 100 on a cloud environment 300 can instruct optimal improvement countermeasures in consideration of the production lines of all the producible factories 311, 312, and 313. All producible factories may include own factories, other companies' factories, and both own and other companies' factories.

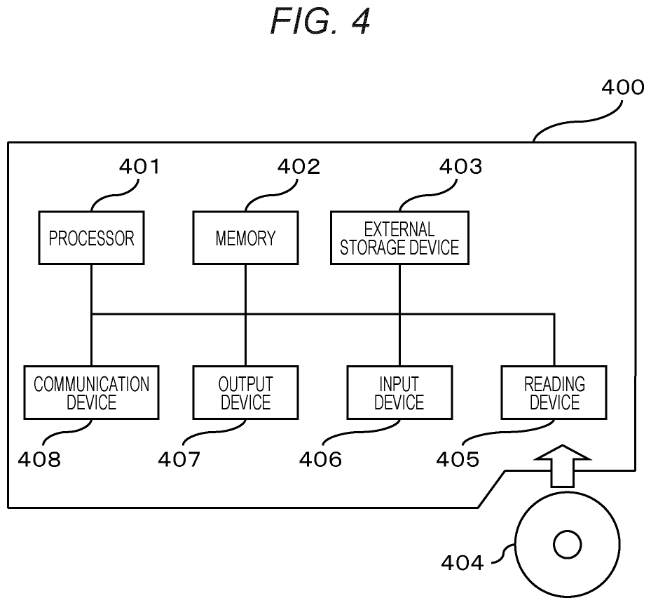

FIG. 4 is a diagram illustrating an example of the hardware configuration of the production information management system. The production information management system 100 can be implemented by a general computer 400 including a processor 401, a memory 402, an external storage device 403 such as a hard disk drive (HDD), a reading device 405 that reads or writes information from or to a portable storage medium 404 such as a compact disk (CD) or a digital versatile disk (DVD), an input device 406 such as a keyboard, a mouse, or a bar code reader, an output device 407 such as a display, and a communication device 408 that communicates with another computer via a communication network such as the Internet, or a network system that includes a plurality of the computers 400.

For example, the processing unit 130 can be implemented by loading a predetermined program stored in the external storage device 403 into the memory 402 and executing the program by the processor 401. The input/output unit 110 can be implemented by the processor 401 using the input device 406 and the output device 407. The storage unit 140 can be implemented by the processor 401 using the memory 402 or the external storage device 403.

This predetermined program may be downloaded to the external storage device 403 from the storage medium 404 via the reading device 405 or from the network via the communication device 408, and then loaded onto the memory 402 and executed by the processor 401.

The program may be directly loaded onto the memory 402 from the storage medium 404 via the reading device 405 or from the network via the communication device 408, and executed by the processor 401.

The present invention is not limited thereto, and the production information management system 100 may be, for example, a wearable computer that can be worn by the worker, such as a headset, goggles, glasses, or an intercom.

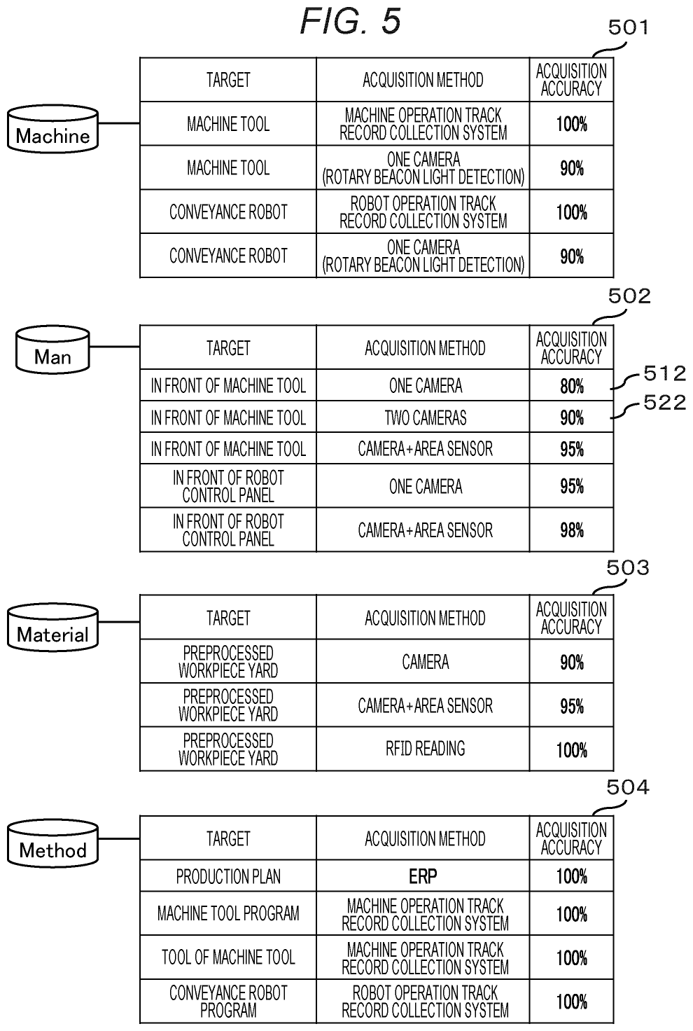

FIG. 5 is a view illustrating an example of the data structure of 4M data acquisition accuracy definition information.

The 4M data acquisition accuracy definition information 242a includes tables 501, 502, 503, and 504 that define the data acquisition accuracy for each acquisition target and acquisition method included in the 4M data. The acquisition accuracy can be improved by combination of acquisition methods. For example, in the man table 502, in a case of acquiring the state (e.g., presence/absence) of a person in front of the machine tool, an acquisition accuracy 512 is defined as “80%” for one camera, but an acquisition accuracy 522 is defined as “90%” for two cameras. This is defined as above because the influence of a blind spot or the like can be eliminated by increasing the viewpoint of the camera. The acquisition accuracy may be set based on a result of a basic experiment or a similar installation case.

The definition of the acquisition accuracy that is more in line with the current situation may be obtained by having the processing unit 130 include a 4M acquisition accuracy definition update unit that is updated as needed based on an operation track record in an actually installed production line. The definition of the acquisition accuracy according to the acquisition method is stored similarly in the machine table 501, the material table 503, and the method table 504.

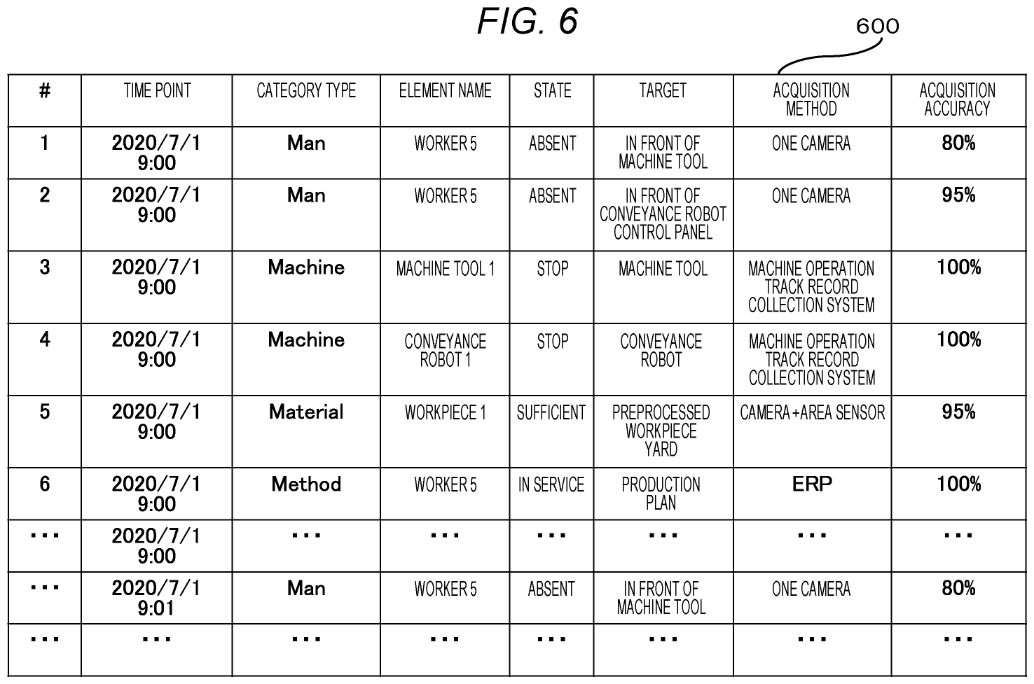

FIG. 6 is a table illustrating an example of the data structure of 4M data. Here, an example of a time series table 600 in which data are stored in time series is illustrated.

The time series table 600 is an example of a time series data group of 4M data, and represents each state of 4M in time series. For example, data (e.g., the acquisition target, the acquisition state, the acquisition method, and the acquisition accuracy for each category type and each element name) representing a state for each of 4M are collected and recorded periodically (e.g., every minute). Each record of the time series table 600 stores a time point (start time point in time point interval), which M of 4M it is, a name of an element belonging to the M, and a state of the element in association with one another. For example, according to the example of FIG. 6, regarding man, it is indicated that a worker 5 is absent in front of the machine tool and in front of the conveyance robot control panel in a time point interval between 09:00 on July 1 and 09:01 on July 1.

According to the time series table 600, a state combination for each time point interval (e.g., for every minute) is specified. For each of the viewpoints of 4M, the state of the element belonging to the viewpoint of the M may be a state described in data collected from the manufacturing site 190, or may be a state in which something has been specified using a measurement value described in the collected data.

For each of 4M data, acquisition accuracy is calculated and given with reference to the 4M data acquisition accuracy definition information 242a. For example, since the absence state of the worker 5 in front of the machine tool of “#1” is a result acquired by one camera, the acquisition accuracy is given as 80%. In the present embodiment, the unit of time point is month, day, hour, and minute, but may be coarser or finer than that.

When the state of the 4M data changes in the unit time, the 4M data acquisition accuracy calculation unit 132 may determine the description content of the 4M data. For example, in a case where the unit time is “1 minute”, regarding presence/absence of man, if there is a state of “presence” for a certain period of time or more (e.g., 5 seconds) during one minute, the 4M data acquisition accuracy calculation unit 132 may determine the 4M state of the unit time as “presence”.

The 4M state may have not only an instantaneous state of each unit time but also a state transition due to a predetermined event related to the 4M state. For example, the state of “alarm on” of the machine tool of “machine” becomes “alarm off” in a state where the user notices the alarm and cancels the alarm. However, if it is necessary to take another handling before recovering to the normal operation after canceling the alarm, the state transition from the occurrence of the alarm to the normal operation is held as “under alarm handling”. By having a state transition such as “under alarm handling” as a 4M state, it is possible to discriminate “setup loss” of the machine tool that does not become zero in a planned work and “short-time breakdown loss” of the machine tool that ideally becomes zero in an unplanned work due to the occurrence of an abnormal situation. In the state of “under alarm handling”, an unplanned work is in progress even if “alarm off”, and therefore it can be determined not as “setup loss” but as “short-time breakdown loss of a machine tool”.

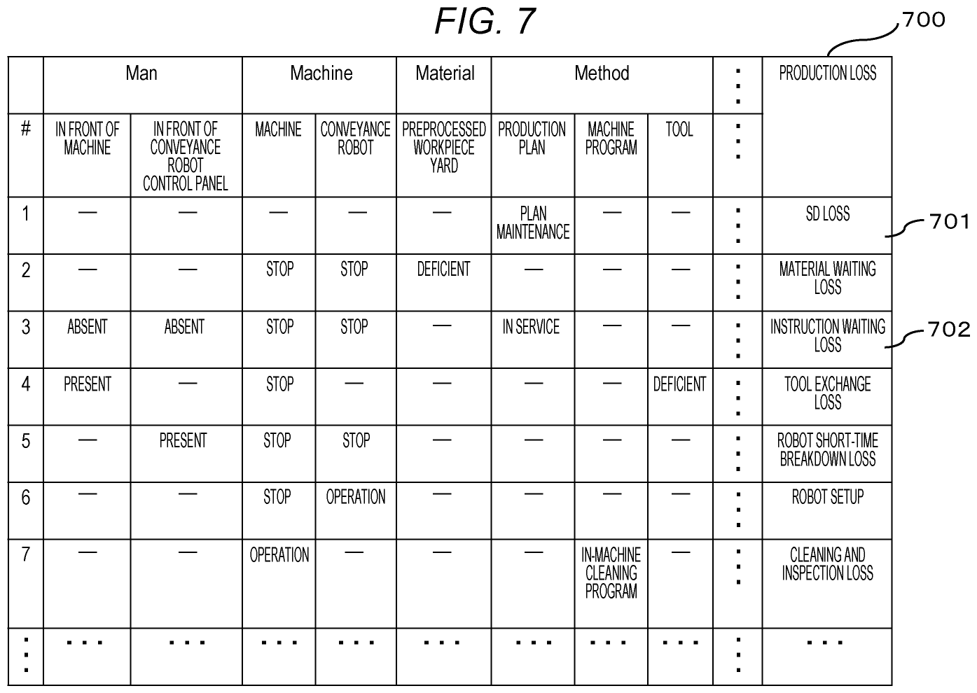

FIG. 7 is a table illustrating an example of the data structure of a production loss analysis model by combination of 4M data. A production loss analysis model table 700 represents a correspondence relationship analyzed in advance between state combination (combination of states of 4M) and production loss. One row of the production loss analysis model table 700 represents a correspondence relationship between one state combination and one production loss. The state “-” means an unspecified state.

The state combination is data in which acquired data of 4M data are put together at the identical time point (unit time treated as identical), i.e., in time series. According to the example illustrated in FIG. 7, presence/absence of a worker “in front of machine” and “in front of conveyance robot control panel” is used as 4M data for “man”, operation/stop of “machine” and “conveyance robot” is used as 4M data for “machine”, excess/deficiency of “preprocessed workpiece yard” is used as 4M data for “material”, and in service/plan maintenance of “production plan”, the operation state of “machine program” (in-machine cleaning program processing in progress and the like), excess/deficiency of “tool”, and the like are used as 4M data for “method”.

For example, in a case where the state of the production plan of “Method” is plan maintenance (planned production suspension), the “SD loss” of a data row 701 can be uniquely determined regardless of the state of other items of 4M. The “instruction waiting loss” in a data row 702 is a part of “short-time breakdown loss”, and indicates a combined case of each state in which man in front of machine is absent, man in front of conveyance robot control panel is absent, the machine of machine is stopped, the conveyance robot of machine is stopped, and the production plan of method is in service.

In the present embodiment, the correspondence between the production loss and the state combination is presented as an example in a table format, but may be defined in another format. For example, it may be defined in XML format according to a standard of decision model and notation (DMN). According to this method, implementation by a computer program becomes easy.

The state combination may be defined by a decision tree in which each state of 4M is branch and the final arrival point is production loss. This method facilitates visual interpretation of the production loss analysis model by the analysis model display unit 123.

In the present embodiment, the production loss analysis model table 700 having the state combination as an input and the production loss as an output is prepared in advance, but, instead of the table, a learned model (e.g., a neural network) having the state combination as an input and the production loss as an output may be used. Alternatively, the association of the analysis model information with the 4M data may be received by the analysis model definition unit 133 from the interface device, or may be edited and updated. In that case, the analysis model display unit 123 displays the history before/after and middle of editing.

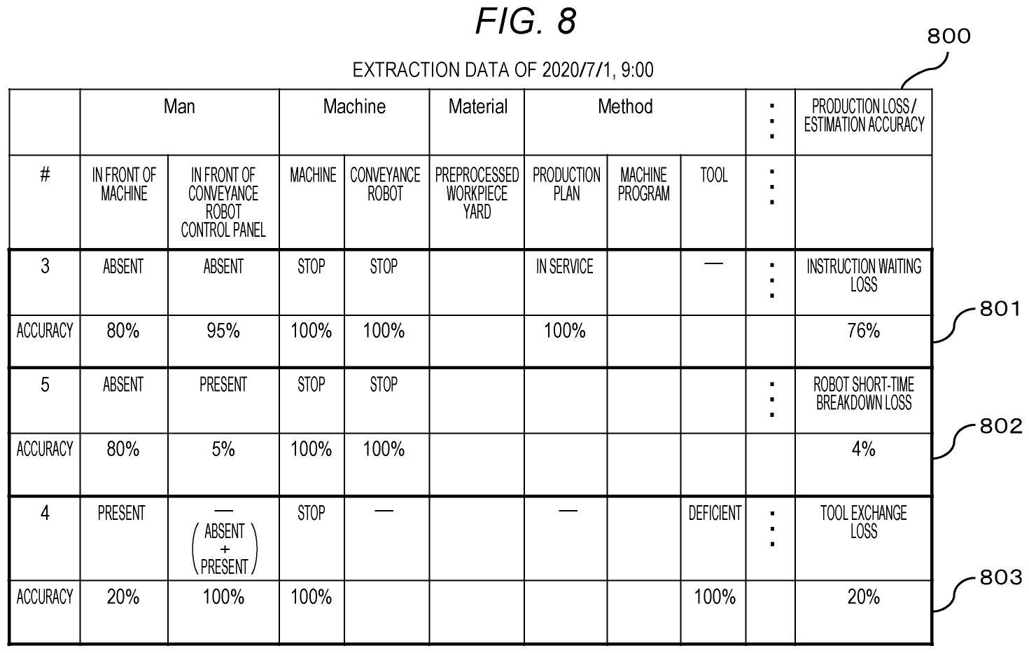

FIG. 8 is a table illustrating an example of the data structure of production loss information. A production loss information table 800 includes a result of production loss determination for each time point and estimation accuracy thereof. The example of FIG. 8 is an example of a result of analyzing the 4M data at the time point of “2020/7/1 9:00” calculated by the production loss estimation accuracy calculation unit 134 using the time series table 600 of FIG. 6 and the production loss analysis model table 700 of FIG. 7 as inputs.

A data row 801 indicates estimation accuracy in a case where it is determined that the production loss is the instruction waiting loss from the combination of 4M data of the time point. The estimation accuracy of the production loss is calculated by multiplication of the acquisition accuracy of each 4M data related to the determination of the instruction waiting loss. That is, the estimation accuracy of the “instruction waiting loss” is 76% by calculating 80% of “man” absence “in front of machine”×95% of “man” absence “in front of conveyance robot control panel”×100% of “machine” of “machine” stopping×100% of “conveyance robot” of “machine” stopping×100% of the “production plan” of “method” in service of the data related to the determination of the “instruction waiting loss”.

Here, regarding the production loss in which the acquisition accuracy of the 4M data is not 100%, other possible production loss is calculated as a candidate using an inverse calculation result and its acquisition accuracy. For example, in a data row 802, the accuracy when “man” is present “in front of conveyance robot control panel” is 100%−95% (accuracy when absent)=5%. Using this, as for the state combination of the data row 802, for example, there is a possibility of the robot short-time breakdown loss as the production loss, and as the estimation accuracy of “robot short-time breakdown loss” is 4% by calculating 80% of “man” absent “in front of machine”×5% of “man” present “in front of conveyance robot control panel”×100% of “machine” of “machine” stopping×100% of “conveyance robot” of “machine” stopping.

Similarly, there is also a possibility of tool exchange loss for a data row 803. Regarding the tool exchange loss, in a case where a person in front of machine is present, the presence/absence of a person in front of conveyance robot control panel is arbitrary (accuracy is always 100%). Therefore, the estimation accuracy of “tool exchange loss” is 20% by calculating 20% of “man” present “in front of machine”×100% of “man” present+absent “in front of conveyance robot control panel”×100% of “machine” of “machine” stopping×100% of “tool” of “method” deficient.

The processing procedure of such the production loss estimation accuracy calculation unit 134 will be described later with reference to a flowchart.

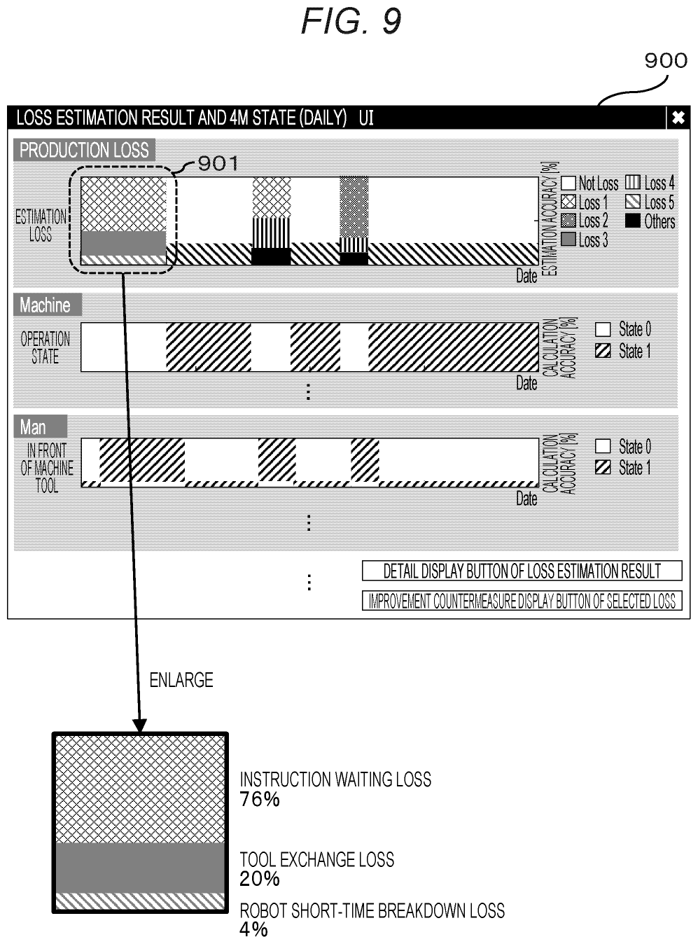

FIG. 9 is a view illustrating an example of a loss estimation result display screen. A loss estimation result display screen 900 displayed by the production loss display unit 124 displays the estimation result of the production loss in time series, and also displays the acquisition result of the 4M data. The loss estimation result display screen 900 includes a detail display button of the loss estimation result for receiving an instruction for detail display of each loss estimation result, and an improvement countermeasure display button of a selected loss for receiving a display instruction for an improvement countermeasure of the selected loss. Upon receiving an instruction for detail display of the loss estimation result, the detail display button of the loss estimation result enlarges and displays the selected loss. Upon receiving a display instruction for an improvement countermeasure of the selected loss, the improvement countermeasure display button of the selected loss displays an improvement countermeasure display screen 1200 including the improvement countermeasure calculated by improvement countermeasure specification processing. The improvement countermeasure display screen 1200 will be described later.

The horizontal axis of the bar chart on the loss estimation result display screen 900 indicates the date (or time point). The vertical axis of the bar chart of the production loss indicates the estimation accuracy, and the vertical axis of each 4M data indicates the acquisition accuracy. This display can visualize the determination result and estimation accuracy of the production loss in time series in association with each other, and each 4M state and acquisition accuracy that serve as the determination source in association with each other, and facilitates specification of the factor of the 4M viewpoint that causes the production loss.

The enlarged display example of a calculation example 901 of the production loss is a display example of the estimation result of the data rows 801 to 803 illustrated in FIG. 8. Since the estimation accuracy of the instruction waiting loss is 76%, the estimation accuracy of the tool exchange loss is 20%, and the estimation accuracy of the robot short-time breakdown loss is 4%, the total of them is indicated as 100%, and the ratio can be visually confirmed. Therefore, it becomes easy to simultaneously examine countermeasures for a plurality of candidates for the cause of the production loss.

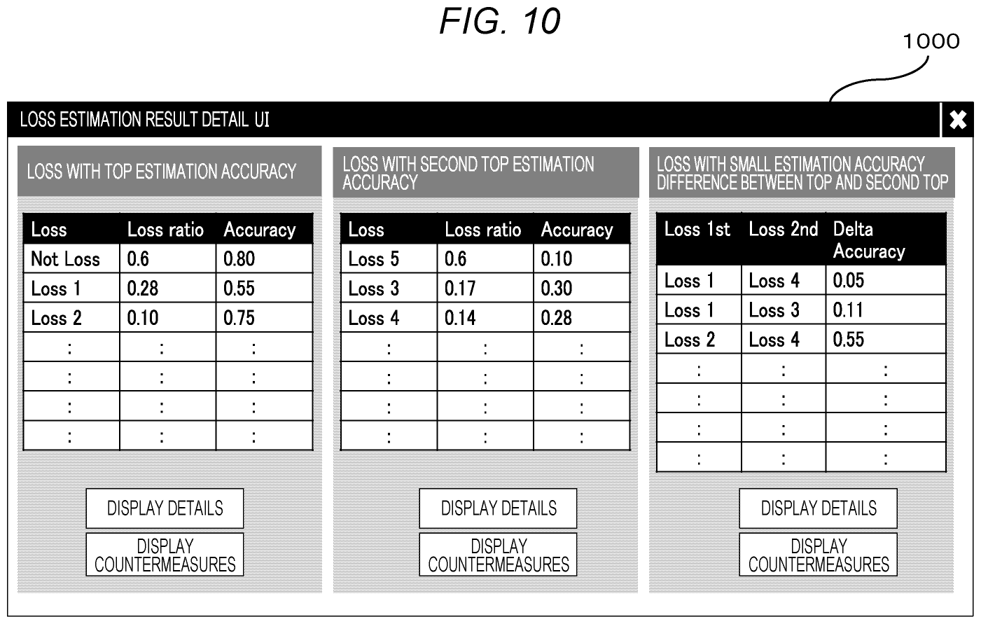

FIG. 10 is a view illustrating an example of a rank display screen of a production loss calculation result in a predetermined period. A rank display screen 1000 has display of items of production loss calculated for each order of estimation accuracy (left and center tables in FIG. 10), and the priority order of countermeasures can be examined. In a plurality of production losses estimated in the same time frame (the right table of FIG. 10), the display of production losses having a small difference in estimation accuracy enables confirmation of details of the 4M state in which there is a possibility of erroneously determining the production loss.

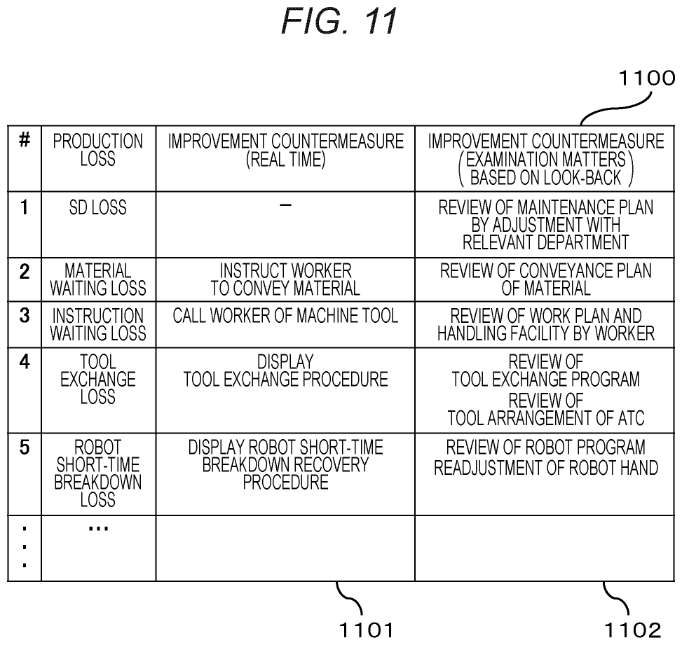

FIG. 11 is a table illustrating an example of the data structure of improvement countermeasure definition information. An improvement countermeasure definition information table 1100 is stored in the improvement countermeasure storage unit 145, and for each production loss defined in the production loss analysis model table 700 of FIG. 7, improvement countermeasures (examination matters in real time and based on look-back) for improving the loss are defined and stored.

For one production loss, there may be a plurality of improvement countermeasures for the production loss. It is desirable that there are different improvement countermeasures, for example, between a case of detecting an occurrence situation in real time and executing countermeasures and a case of looking back a production loss occurred in a predetermined period, examining drastic improvement countermeasures, and executing countermeasures.

An improvement countermeasure (real time) column 1101 of the improvement countermeasure definition information table 1100 stores in advance an example of improvement countermeasures in real time. For example, for material waiting loss, the material waiting state is eliminated by taking an improvement countermeasure of instructing the worker to convey the material. For robot short-time breakdown loss, an improvement countermeasure for supporting quick recovery of the robot is associated by displaying the robot short-time breakdown recovery procedure.

An improvement countermeasure (examination matters based on look-back) column 1102 of the improvement countermeasure definition information table 1100 stores in advance an example of medium- to long-term examination matters based on look-back on production loss occurred in a predetermined period. For example, for material waiting loss, examination of a change in mechanism in which the conveyance plan of the material is reviewed so that the material is conveyed to an appropriate place at a required time is taken as an improvement countermeasure. For robot short-time breakdown loss, as measures for preventing robot short-time breakdown, maintenance management of facilities such as review of the robot program and readjustment of the robot hand is taken as improvement countermeasures.

By presenting predefined improvement countermeasures for each production loss as described above, it is possible to eliminate the generated production loss regardless of the experience of the person working in the production line, and it is possible to improve productivity. In the present embodiment, the improvement countermeasures are defined in advance, but the improvement countermeasures executed based on experience of a skilled person may be updated as needed or additionally defined. Improvement countermeasures defined in other production lines or other factories may be shared and referred to.

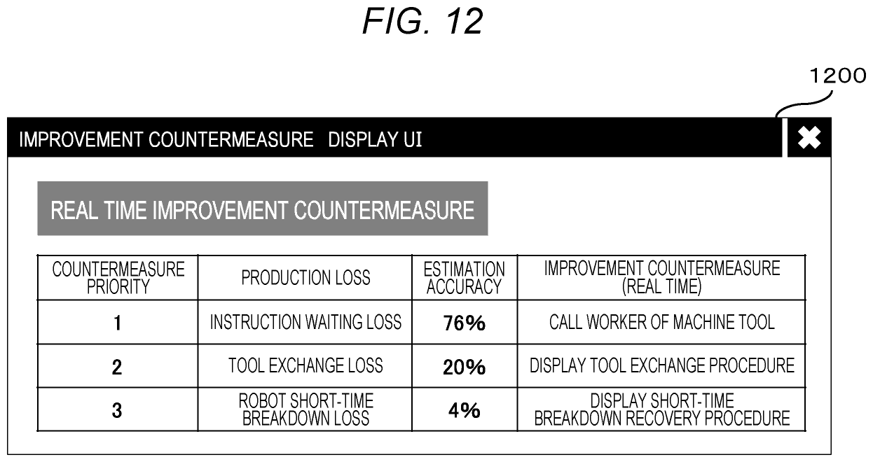

FIG. 12 is a view illustrating an example of an improvement countermeasure display screen that displays improvement countermeasures in real time. The improvement countermeasure display screen 1200 is displayed by the improvement countermeasure display unit 125, and is an example in which predefined real-time countermeasures are presented with priority in descending order of estimation accuracy of production loss with respect to the production loss in the production loss information table 800 calculated based on the state of 4M of “2020/7/1 9:00 to 9:01” in the time series table 600 of FIG. 6. In this example, the estimation accuracy of instruction waiting loss is the highest at 76%, and calling the worker of the machine tool is presented as the highest priority improvement countermeasure.

FIG. 12 of the present embodiments displays a list of countermeasure plans for three production losses with priority, but another display form may be used. For example, the display form may be an interactive one in which one plan of improvement countermeasure with the highest priority is presented, and the next countermeasure is presented if the situation is not improved by the presented countermeasure plan. With this display form, the worker can concentrate only on the presented countermeasure, and even if the worker has little experience, the worker can quickly implement the improvement countermeasures without hesitation by sequentially executing the countermeasures. Alternatively, both immediate improvement countermeasures in a case where the occurrence status of production loss is detected in real time and countermeasures are executed and medium- to long-term improvement countermeasures for the production loss occurred in a predetermined period may be displayed. According to this display form, improvement countermeasures to be taken can be seen from a higher perspective.

FIG. 13 is a view illustrating an example of a flowchart of improvement countermeasure specification processing. The improvement countermeasure specification processing is started when a start instruction is received by the user via the interface device.

First, the input/output unit 110 receives an input of a processing unit time of production loss analysis (step S001). All subsequent processing is executed along the processing unit time set here. Each processing unit may perform processing in a finer unit time, and adjust the granularity of information with reference to the unit time set in this step when proceeding to the next step.

Then, the sensor data acquisition unit 131 receives inputs from the machine tool 191, the robot 192, the camera 193, and the other sensors 194 via the input/output unit 110, and stores the sensor data information 241 in the sensor data storage unit 141 (step S002).

Then, the 4M data acquisition accuracy calculation unit 132 receives inputs of the sensor data information 241 and the 4M data acquisition accuracy definition information 242a via the input/output unit 110, and performs 4M data acquisition accuracy calculation processing of storing the 4M data information 242b in the 4M data storage unit 142 (step S003).

Then, the production loss estimation accuracy calculation unit 134 receives inputs of the 4M data information 242b and the analysis model information 243 via the input/output unit 110, performs production loss estimation accuracy calculation processing described later, and stores the production loss information 244 in the production loss storage unit 144 (step S004).

Then, the improvement countermeasure selection unit 135 receives inputs of the production loss information 244 and the improvement countermeasure definition information 245a via the input/output unit 110, and stores the improvement countermeasure information 245b in the improvement countermeasure storage unit 145 (step S005).

Then, the input/output unit 110 receives an instruction for display of each piece of information (step S006). If the instruction for display is not received in the predetermined time (“No” in step S006), the input/output unit 110 ends the improvement countermeasure specification processing.

If the instruction for display is received in the predetermined time (“Yes” in step S006), the display unit 120 instructs to display any one or a plurality of the 4M data display unit 122, the analysis model display unit 123, the production loss display unit 124, and the improvement countermeasure display unit 125 by using the screen information to be displayed or the like, based on the display instruction of various types of information set in the previous step (step S007). Then, the display unit 120 ends the improvement countermeasure specification processing.

The above is the flow of the improvement countermeasure specification processing. In the improvement countermeasure specification processing, collection of 4M data, which is site data, specification of acquisition accuracy, analysis of production loss, and calculation of estimation accuracy are performed, and improvement countermeasure for production loss can be displayed according to the estimation accuracy. Therefore, it is possible to indicate production loss information in consideration of the acquisition accuracy and the estimation accuracy of the site data.

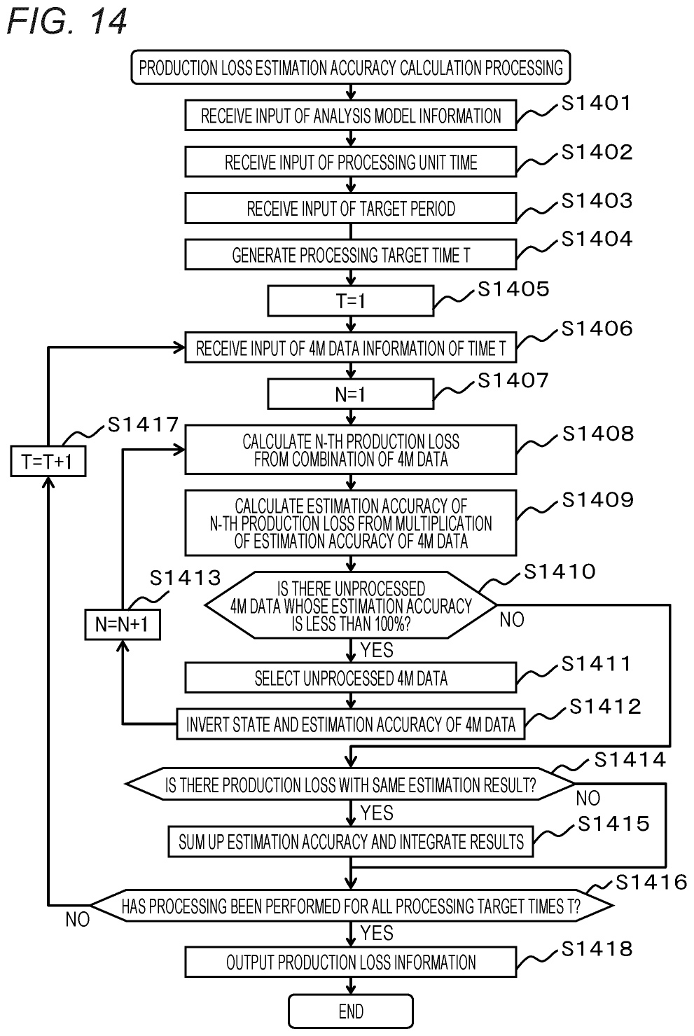

FIG. 14 is a view illustrating an example of a flowchart of production loss estimation accuracy calculation processing. The production loss estimation accuracy calculation processing is started in step S004 of the improvement countermeasure specification processing.

First, the input/output unit 110 receives an input of the analysis model information 243 (step S1401). Then, the input/output unit 110 receives an input of a processing unit time of production loss analysis (step S1402). In the present embodiment, the processing unit time is 1 minute, but may be coarser or finer than that.

Then, the input/output unit 110 receives an input of a target period of the production loss analysis (step S1403). For example, an operation period of one week such as “2020/7/1 8:00 to 2020/7/5 18:00” may be input.

Then, the production loss estimation accuracy calculation unit 134 generates a processing target time T from the target period in which the input is received and the processing unit time (step S1404). The processing target time T is generated by the number of integer values obtained by rounding up, to the first decimal place, the number obtained by dividing the target period by the processing unit time. For example, in a case where the target period is 60 minutes and the processing unit time is 1 minute, the processing target time T is from T=1 to T=60.

Then, the production loss estimation accuracy calculation unit 134 sets an initial value T=1 of the processing target time T (step S1405).

Then, the input/output unit 110 receives an input of the 4M data information 242b at the processing target time T (step S1406).

Then, the production loss estimation accuracy calculation unit 134 sets an initial value N=1 of a variable N that stores the number of processing of production loss (step S1407).

Then, the production loss estimation accuracy calculation unit 134 calculates the N-th production loss from the state combination of the 4M data information at the processing target time T (step S1408).

Then, the production loss estimation accuracy calculation unit 134 calculates the estimation accuracy of the N-th production loss by multiplication of each estimation accuracy of the 4M data necessary for determining the production loss having been calculated (step S1409).

Then, the production loss estimation accuracy calculation unit 134 determines whether or not there is unprocessed (production loss determination is unprocessed) 4M data whose estimation accuracy is less than 100% among the 4M data information of the processing target time T (step S1410).

If there is unprocessed 4M data (“Yes” in step S1410), the production loss estimation accuracy calculation unit 134 selects one of the unprocessed 4M data (step S1411).

Then, the production loss estimation accuracy calculation unit 134 inverts the state and the estimation accuracy of the selected 4M data (step S1412). For example, in #1 of the time series table 600 of the 4M data information 242b in FIG. 6, the estimation accuracy with which the state of the worker 5 of “man” is “absent” is “80%”. If this 4M data is unprocessed, when the state and the estimation accuracy are reversed, the state becomes “present”, and the estimation accuracy becomes “20%”.

Then, the production loss estimation accuracy calculation unit 134 adds the number N of processing of production loss by 1 (step S1413). Then, the control returns to step S1408.

If there is no unprocessed 4M data (“No” in step S1410), the production loss estimation accuracy calculation unit 134 determines whether or not there is a production loss with the same estimation result among the N production losses calculated at the same T (step S1414). If there is not any production loss with the same estimation result at the same T (“No” in step S1414), the production loss estimation accuracy calculation unit 134 proceeds with the control to step S1416.

If there is a production loss with the same estimation result at the same T (“Yes” in step S1414), the production loss estimation accuracy calculation unit 134 sums up the estimation accuracy of the same production loss and integrates the results (step S1415). For example, in the production loss information table 800 of FIG. 8, the tool exchange loss is an example of a result obtained by integrating “tool exchange loss” that is a production loss estimated with “absence” (acquisition accuracy 95%) and “presence” (acquisition accuracy 5%) of the state of “in front of conveyance robot control panel” of “man”. This is because the result of “tool exchange loss” becomes “tool exchange loss” even if the state “in front of conveyance robot control panel” of “man” is arbitrarily present or absent.

Then, the production loss estimation accuracy calculation unit 134 determines whether or not processing has been performed for all the processing target times T (step S1416).

If the processing has not been performed for all the processing target times T (“No” in step S1416), the production loss estimation accuracy calculation unit 134 adds the processing target time T by 1 (step S1417). Then, the control returns to step S1406.

If the processing has been performed for all the processing target times T (“Yes” in step S1416), the production loss estimation accuracy calculation unit 134 outputs the production loss information 244 (step S1418). Then, the production loss estimation accuracy calculation unit 134 ends the production loss estimation accuracy calculation processing.

The above is the production information management system to which the first embodiment according to the present invention is applied. According to the first embodiment according to the present invention, the production loss can be calculated with estimation accuracy by utilizing 4M data. This can facilitate confirmation of the reliability of the calculation result. It is possible to provide improvement countermeasures for production loss with priority based on estimation accuracy. This can sequentially execute countermeasures from the highly effective one, and improve productivity more quickly.

### Second Embodiment

In the present embodiment, an example will be described in which an improvement plan of a device configuration that acquires 4M data is presented based on estimation accuracy and occurrence frequency of production loss. As described above, 4M data is acquired from the machine tool 191, the robot 192, the camera 193, and the other sensors 194 of the manufacturing site 190. However, there are various degrees of freedom as to from which target and what device configuration data is acquired, thereby affecting the acquisition accuracy of 4M data. Since the production information management system according to the second embodiment is basically similar to the production information management system according to the first embodiment, differences will be mainly described below.

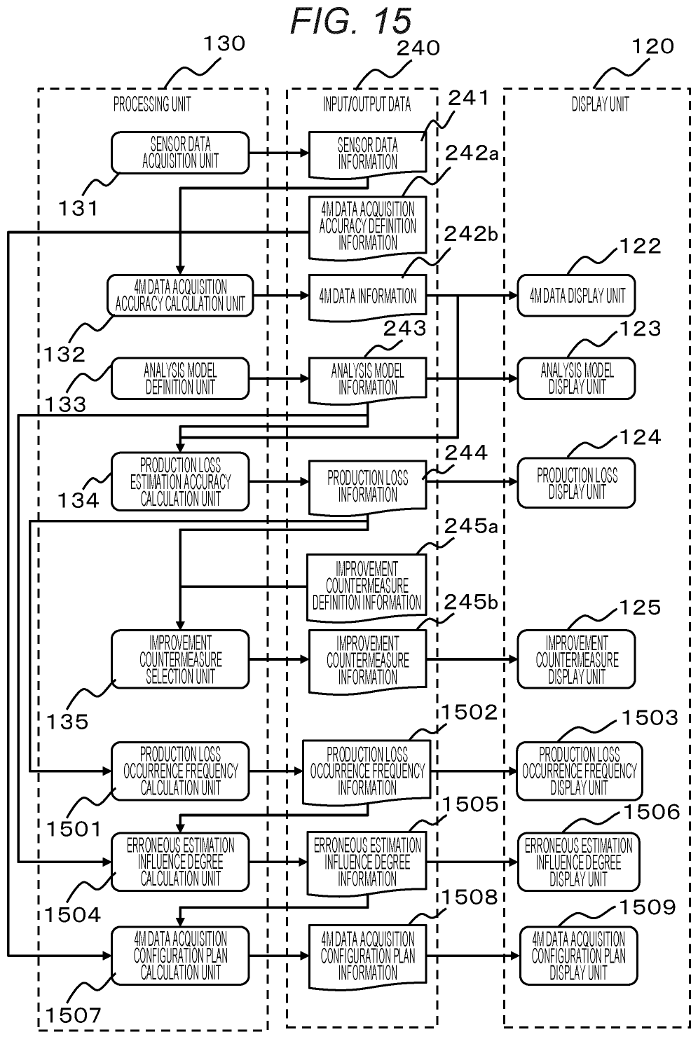

FIG. 15 is a view illustrating an example of the data flow according to input and output of the second embodiment. With respect to FIG. 2 of the first embodiment, a production loss occurrence frequency calculation unit 1501, an erroneous estimation influence degree calculation unit 1504, and a 4M data acquisition configuration plan calculation unit 1507 are added to the processing unit 130, production loss occurrence frequency information 1502, erroneous estimation influence degree information 1505, and 4M data acquisition configuration plan information 1508 are added to the input/output data 240, and a production loss occurrence frequency display unit 1503, an erroneous estimation influence degree display unit 1506, and a 4M data acquisition configuration plan display unit 1509 are added to the display unit 120.

The production loss occurrence frequency calculation unit 1501 uses the production loss information 244 as an input, and outputs the production loss occurrence frequency information 1502 in a target period. The production loss occurrence frequency display unit 1503 displays the production loss occurrence frequency information 1502.

The erroneous estimation influence degree calculation unit 1504 uses the analysis model information 243 and the production loss occurrence frequency information 1502 as inputs, and outputs the erroneous estimation influence degree information 1505. The erroneous estimation influence degree display unit 1506 displays the erroneous estimation influence degree information 1505.

The 4M data acquisition configuration plan calculation unit 1507 uses the 4M data acquisition accuracy definition information 242a and the erroneous estimation influence degree information 1505 as inputs, and outputs the 4M data acquisition configuration plan information 1508. The 4M data acquisition configuration plan display unit 1509 displays 4M data acquisition configuration plan information 1508. The data flow illustrated in FIG. 15 is an example, and may be different depending on a modification of the present embodiment.

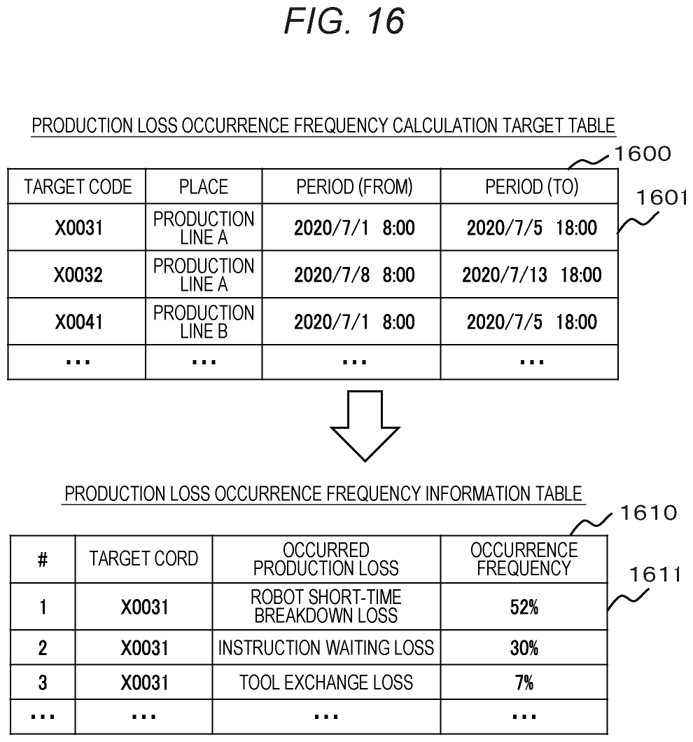

FIG. 16 is a table illustrating an example of the data structure of production loss occurrence frequency information. A production loss occurrence frequency calculation target table 1600 stores a place, a period (from), and a period (to) that are calculation targets of the occurrence frequency of the production loss among the operation track records of the production information management system 100.

A production loss occurrence frequency information table 1610 corresponds to the production loss occurrence frequency information 1502, and stores, as an occurrence frequency, a time ratio of each production loss having occurred, among the times of the production loss occurred in the target period calculated by the production loss occurrence frequency calculation unit 1501. For example, a data row 1611 indicates that robot short-time breakdown loss accounts for 52% of time of the production loss occurred in the target period.

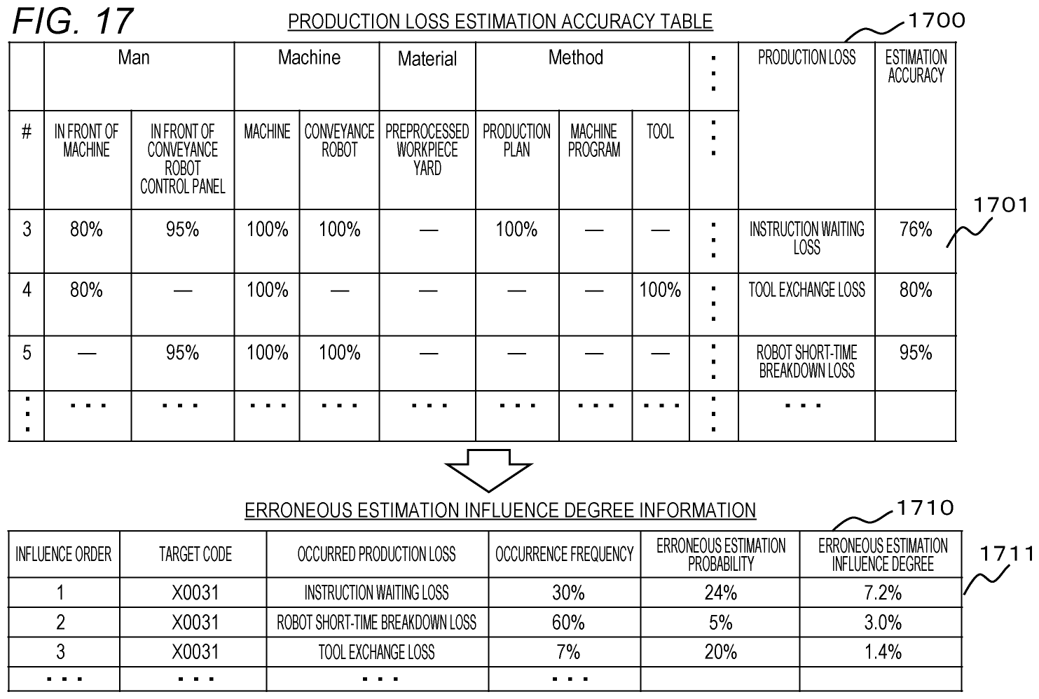

FIG. 17 is a table illustrating an example of the data structure of erroneous estimation influence degree information. Based on the production loss analysis model table 700, a production loss estimation accuracy table 1700 allocates the acquisition accuracy of the 4M data to the 4M state necessary for estimation of each production loss from the current target 4M acquisition configuration, and holds the estimation accuracy calculated from multiplication of the state combinations. For example, the instruction waiting loss of a data row 1701 includes a combination of five 4M states, and the estimation accuracy is 76% from the multiplication of the acquisition accuracy of each 4M state (80%×95%×100%×100%×100%).

An erroneous estimation influence degree information table 1710 corresponds to the erroneous estimation influence degree information 1505, and stores the influence degree due to the erroneous estimation of production loss occurred in the target period, calculated by the erroneous estimation influence degree calculation unit 1504. The erroneous estimation influence degree is calculated by multiplication of the occurrence frequency of each production loss by the erroneous estimation probability. Here, the erroneous estimation probability is a reciprocal of the estimation accuracy. For example, in the instruction waiting loss of a data row 1711, the erroneous estimation probability is the reciprocal of the estimation accuracy of 76%, that is, 100%−76%=24% from the data row 1701 of the production loss estimation accuracy table 1700. The erroneous estimation influence degree is 30%×24%=7.2%.

It is found from the erroneous estimation influence degree information table 1710 that the erroneous estimation influence degree (7.2%) of the instruction waiting loss is the largest as compared with the influence degrees of other production losses. This is considered to be because the occurrence frequency of the instruction waiting loss is 30%, which is smaller than 60% of the robot short-time breakdown loss, but the erroneous estimation probability is high, and hence the influence degree due to erroneous estimation has become high. This result indicates that the priority is high to improve the estimation accuracy of the instruction waiting loss having a high influence degree of erroneous estimation. In order to further improve the estimation accuracy, it is only required to focus on the 4M data that causes accuracy reduction. Referring to the data row 1701, the data acquisition accuracy of the person in front of the machine is 80%, which is the lowest as compared with the acquisition accuracy of the other 4M data, and hence it can be an improvement candidate of the acquisition means.

Thus, by outputting the erroneous estimation influence degree, it is possible to easily identify a 4M data acquisition means (device configuration for acquisition) to be improved. With this method, it is possible to output an improvement candidate of an acquisition means for effective 4M data for achieving highly accurate production loss analysis for improving productivity.

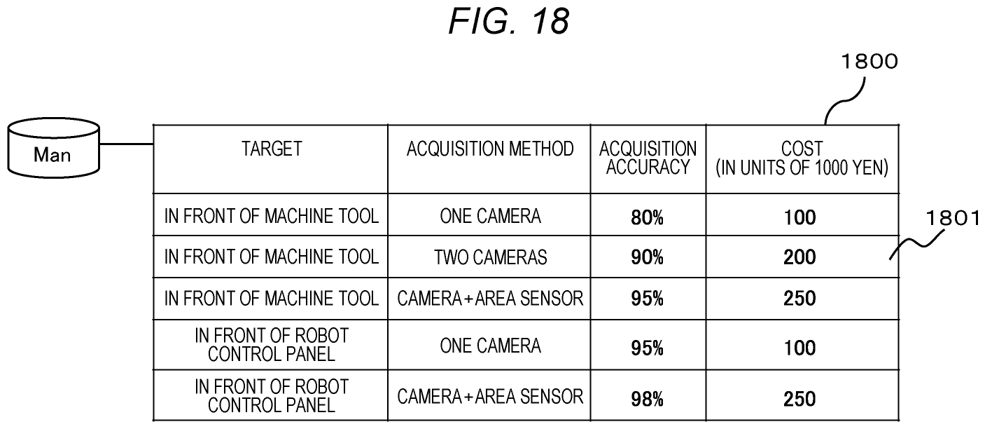

FIG. 18 is a table illustrating an example of the data structure of 4M data acquisition configuration plan information. A 4M data acquisition configuration definition table 1800 is a table in which acquisition accuracy and cost information of data are associated for each acquisition target and acquisition method included in 4M data. For example, in a data row 1801, acquisition accuracy (90%) in a case where information on the person in front of the machine tool is acquired by two cameras is associated with cost information (200,000 yen).

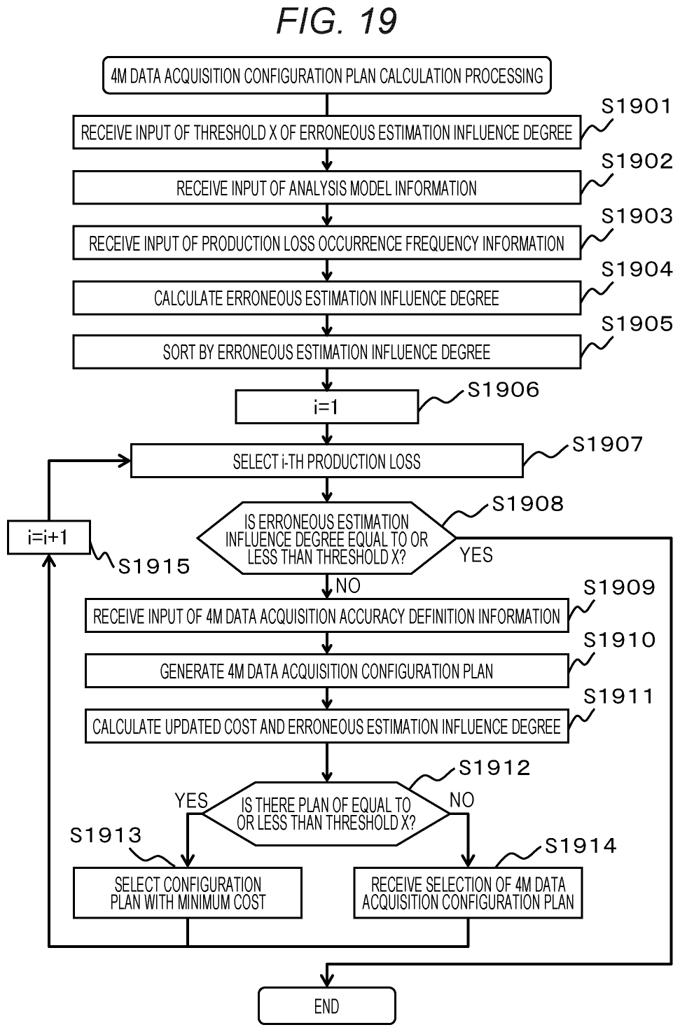

FIG. 19 is a view illustrating an example of a flowchart of 4M data acquisition configuration plan calculation processing. The 4M data acquisition configuration plan calculation processing is started when a start instruction is received by the user via the interface device.

First, the input/output unit 110 receives an input of a threshold X of the erroneous estimation influence degree from the user (step S1901). That is, the threshold X is a threshold of the erroneous estimation influence degree for extracting 4M data whose acquisition configuration is desired to be improved, and serves as a reference for extracting a production loss of the erroneous estimation influence degree exceeding the threshold X.

Then, the input/output unit 110 receives an input of the analysis model information 243 (step S1902).

The input/output unit 110 receives an input of the production loss occurrence frequency information 1502 (step S1903).

Then, the erroneous estimation influence degree calculation unit 1504 calculates the erroneous estimation influence degree (step S1904). Specifically, for each production loss included in the production loss occurrence frequency information 1502, the erroneous estimation influence degree calculation unit 1504 calculates the erroneous estimation influence degree by multiplication of the reciprocal of the estimation accuracy of the analysis model information 243 and the occurrence frequency of the production loss occurrence frequency information 1502, and outputs the erroneous estimation influence degree information 1505.

Then, the erroneous estimation influence degree calculation unit 1504 sorts the erroneous estimation influence degree information 1505 in descending order of the erroneous estimation influence degree (step S1905). The erroneous estimation influence degree calculation unit 1504 also performs numbering with serial numbers 1 and 2 for the production loss in descending order of the erroneous estimation influence degree.

Next, the 4M data acquisition configuration plan calculation unit 1507 sets an initial value i=1 of a variable i (step S1906).

Then, the 4M data acquisition configuration plan calculation unit 1507 selects the i-th production loss among the numbered production losses (step S1907).

Then, the 4M data acquisition configuration plan calculation unit 1507 determines whether or not the erroneous estimation influence degree of the selected production loss is equal to or less than the threshold X (step S1908). If the erroneous estimation influence degree is equal to or less than the threshold X (“Yes” in step S1908), the 4M data acquisition configuration plan calculation unit 1507 ends the 4M data acquisition configuration plan calculation processing.

If exceeds the threshold X (“No” in step S1908), the 4M data acquisition configuration plan calculation unit 1507 receives an input of the 4M data acquisition accuracy definition information 242a from the interface device (step S1909).

Then, the 4M data acquisition configuration plan calculation unit 1507 generates a plan of the acquisition configuration of 4M data (plan by which the acquisition accuracy becomes high) (step S1910). Specifically, the 4M data acquisition configuration plan calculation unit 1507 generates the 4M data acquisition configuration plan 1508 by extracting an alternative plan for acquisition configuration of all the 4M data by which the acquisition accuracy becomes higher than that in the current state for the items of the 4M data in which the acquisition accuracy of the 4M data is less than 100%. Here, instead of all plans, conditions of the extraction priority may be provided, such as an acquisition configuration plan with the highest acquisition accuracy or the lowest update cost. With this method, it is possible to preferentially generate a higher investment-effective plan.

Then, the 4M data acquisition configuration plan calculation unit 1507 calculates the updated cost and the erroneous estimation influence degree, and updates the 4M data acquisition configuration plan information 1508 (step S1911).

Then, the 4M data acquisition configuration plan calculation unit 1507 determines whether or not the 4M data acquisition configuration plan information 1508 includes a configuration plan equal to or less than the threshold X (step S1912).

If a configuration plan equal to or less than the threshold X is included (“Yes” in step S1912), the 4M data acquisition configuration plan calculation unit 1507 selects the acquisition configuration plan of the 4M data with the minimum update cost (step S1913). With this method, it is possible to select the highest investment-effective configuration plan without the user's selection.

Then, the 4M data acquisition configuration plan calculation unit 1507 adds 1 to the value of the variable i and returns the control to step S1907 (step S1915).

If a configuration plan equal to or less than the threshold X is not included (“No” in step S1912), the input/output unit 110 receives selection of the 4M data acquisition configuration plan from the user via the interface device (step S1914). Then, the input/output unit 110 proceeds with the control to step S1915.

The above is the flow of the 4M data acquisition configuration plan calculation processing. According to the 4M data acquisition configuration plan calculation processing, it is possible to extract an acquisition configuration of 4M data having an erroneous estimation influence degree exceeding the threshold X and present a device configuration plan of a sensor device, a camera, or the like for improving the erroneous estimation influence degree of the configuration.

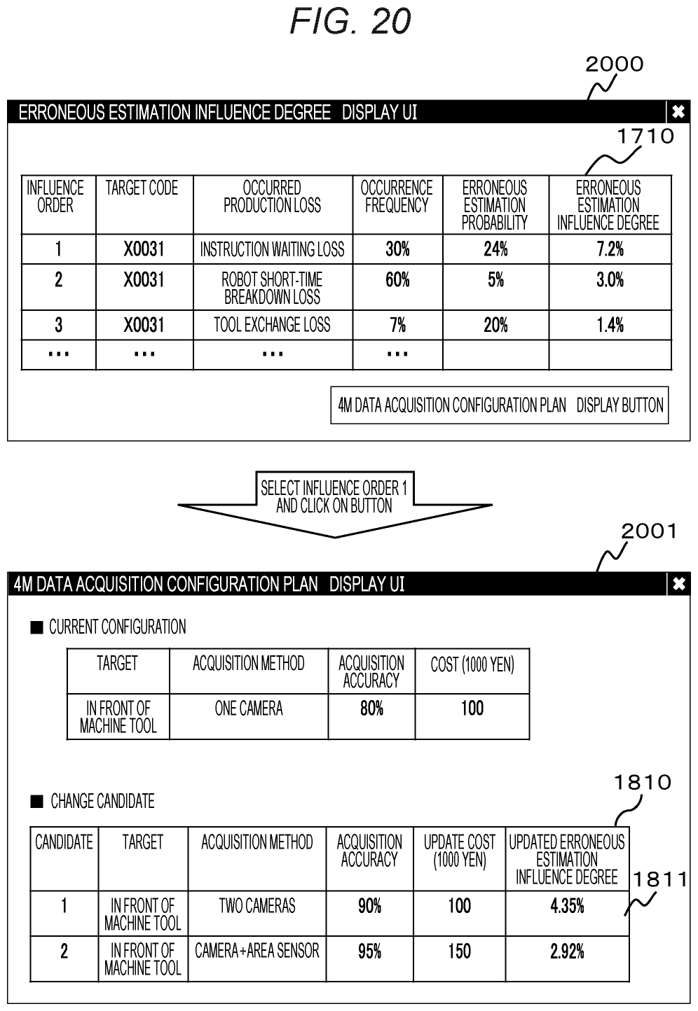

FIG. 20 is a view illustrating an example of a 4M data acquisition configuration plan display screen. An erroneous estimation influence degree display screen 2000 displays the erroneous estimation influence degree for each production loss in which an erroneous estimation has occurred. Specifically, the erroneous estimation influence degree information table 1710 is displayed in a row selectable manner, and a 4M data acquisition configuration plan display button for receiving an instruction to display a 4M data acquisition configuration plan for the production loss of the selected row is displayed.

Then, when any row (e.g., the row of the influence order 1) is selected on the erroneous estimation influence degree display screen 2000 and the click of the button is received, a 4M data acquisition configuration plan display screen 2001 is opened, and the current acquisition method, acquisition accuracy, and cost of the acquisition configuration of the 4M data related to the selected production loss are displayed. The 4M data acquisition configuration plan display screen 2001 displays an acquisition configuration plan as a change candidate, and displays a 4M data acquisition configuration plan table 1810 including, for each candidate, an acquisition method, acquisition accuracy after adoption, an update cost for adoption, and a trial calculation of an erroneous estimation influence degree after update.

The 4M data acquisition configuration plan table 1810 holds the update plan of the 4M data acquisition configuration, the cost for the update, and the updated erroneous estimation influence degree that have been output by the 4M data acquisition configuration plan calculation unit 1507. For example, a data row 1811 indicates a plan to increase the number of cameras to two with respect to the current one, and the update cost is indicated as 200 (in units of 1000 yen)−100 (in units of 1000 yen)=100 (in units of 1000 yen).

The estimation accuracy of the “instruction waiting loss” after update is 85.5% by calculating 90% of “man” absent “in front of machine”×95% of “man” absent “in front of conveyance robot control panel”×100% of “machine” of “machine” stopping×100% of “conveyance robot” of “machine” stopping×100% of in service of “production plan” of “method” of data related to the determination of the “instruction waiting loss”, and the erroneous estimation influence degree is indicated as occurrence frequency 30%×erroneous estimation probability (100%−85.5%=14.5%)=4.35%. Similarly, in a case where the camera and an area sensor are used in combination, the acquisition accuracy increases to 95% but the update cost is 150 (in units of 1000 yen). However, the updated erroneous estimation influence degree can be suppressed to 2.92%.

The above is the production information management system to which the second embodiment according to the present invention is applied. According to the second embodiment according to the present invention, the influence degree due to erroneous estimation of production loss can be calculated from the estimation accuracy and the occurrence frequency. This can quantitatively confirm the reliability of the production information management system. It is possible to provide an improvement countermeasure for a 4M data acquisition configuration together with an evaluation result of the investment effectiveness based on the erroneous estimation influence degree. This can sequentially execute countermeasures from the highly investment-effective one, and improve productivity at lower cost.

The present invention is not limited to the embodiments described above, and includes various modifications. For example, the embodiments described above have been described in detail for the purpose of describing the present invention in an easy-to-understand manner, and are not necessarily limited to those having all the configurations described above. The configuration of a certain embodiment can be replaced partly by the configuration of another embodiment, and the configuration of a certain embodiment can be added to the configuration of another embodiment. The configuration of each embodiment can be partly added to, deleted from, or replaced by another configuration.

A part or all of the above-described configurations, functions, processing units, processing means, and the like may be implemented by hardware by being designed as an integrated circuit or the like. Alternatively, the above configurations, functions, and the like may be implemented by software by a processor interpreting and executing a program that implements each function. Information such as programs, tables, and files for implementing each function can be stored in a recording device such as a memory, a hard disk, and an SSD, or in a recording medium such as an IC card, an SD card, and a DVD.

Control lines and information lines that are considered necessary for the description are illustrated. Not all the control lines and information lines in the product are necessarily illustrated. In reality, almost all the configurations may be considered as being mutually connected.

What is claimed is:

1. A production information management system comprising:
a storage device that stores
4M (man, machine, material, and method) data information including time series data in which a state of each element of 4M per unit time is associated with acquisition accuracy of 4M data defined for each target and acquisition method of 4M, and
analysis model information defining a criterion for determining a production loss from a combination of the 4M data information;
a processor that analyzes the 4M data information by the analysis model information to estimate a production loss, and calculates estimation accuracy for the each production loss to generate production loss information; and
a production loss display unit that displays the production loss information.

2. The production information management system according to claim 1, wherein
the storage device stores improvement countermeasure definition information including an improvement countermeasure associated with production loss,
the processor specifies the improvement countermeasure for the each production loss included in the production loss information, and
an improvement countermeasure display unit that displays, in descending order of the estimation accuracy of the production loss, the improvement countermeasure having been specified is included.

3. The production information management system according to claim 1, wherein
the processor
calculates an occurrence frequency of the production loss included in the production loss information using the time series data,
calculates an erroneous estimation influence degree, which is an influence degree in a case of erroneous estimation, using the occurrence frequency and an erroneous estimation probability, which is a reciprocal of the estimation accuracy, and
calculates an update plan of a device configuration for acquiring the 4M data using the erroneous estimation influence degree and the acquisition accuracy of the 4M data.

4. The production information management system according to claim 1, wherein
the processor acquires a plurality of sensor data acquired from a plurality of sensor devices, and generates the 4M data information by combining the plurality of sensor data.

5. The production information management system according to claim 1, wherein
the processor acquires an operation track record and updates, as needed, the acquisition accuracy of the 4M data stored in the storage device.

6. The production information management system according to claim 1, wherein
the processor stores, in the storage device, a predetermined state caused by a predetermined event occurrence related to the 4M in association with the 4M data information.

7. The production information management system according to claim 1, wherein
the processor includes an analysis model display unit that edits a determination flow of the analysis model information and an association with 4M data information for determination, and
displays a history before/after and middle of editing.

8. The production information management system according to claim 1 comprising:
a 4M data display unit that visualizes and displays the 4M data information as a graph of a ratio of 4M data acquisition accuracy per unit time.

9. The production information management system according to claim 1 comprising:
a production loss display unit that visualizes and displays the production loss information as a graph of a ratio of production loss estimation accuracy per unit time.

10. The production information management system according to claim 1 comprising:
a production loss display unit that displays the 4M data information in association with the production loss information.

11. The production information management system according to claim 1, wherein
the storage device stores improvement countermeasure information including an improvement countermeasure associated with production loss,
the processor specifies the improvement countermeasure for the each production loss included in the production loss information,
an improvement countermeasure display unit that displays, in descending order of the estimation accuracy of the production loss, the improvement countermeasure having been specified is included, and
the improvement countermeasure information includes immediate improvement countermeasures in a case where an occurrence status of production loss is detected in real time and countermeasures are executed and medium- to long-term improvement countermeasures for production loss occurred in a predetermined period.

12. A production information management method using a production information management system, wherein
the production information management system includes
a storage device that stores
4M (man, machine, material, and method) data information including time series data in which a state of each element of 4M per unit time is associated with acquisition accuracy of 4M data defined for each target and acquisition method of 4M, and
analysis model information defining a criterion for determining a production loss from a combination of the 4M data information,
a processor, and a display unit, and
the processor performs
analyzing the 4M data information by the analysis model information to estimate a production loss, and calculating estimation accuracy for the each production loss to generate production loss information, and
production loss displaying of causing the display unit to display the production loss information.
